(19) United States
(12) Patent Application Publication
(10) Pub. No.: US 2025/0353296 A1
(43) Pub. Date: Nov. 20, 2025

(54) LIQUID EJECTION HEAD AND LIQUID EJECTION APPARATUS

(71) Applicant: RISO Technologies Corporation, Tokyo (JP)

(72) Inventors: Meng Fei WONG, Mishima Shizuoka (JP); Satoshi MIURA, Mishima Shizuoka (JP)

(21) Appl. No.: 18/986,632

(22) Filed: Dec. 18, 2024

(30) Foreign Application Priority Data
May 17, 2024 (JP) 2024-081238

(51) Int. Cl. B41J 2/045

(52) U.S. Cl. CPC B41J 2/04588; B41J 2/04581

(57) ABSTRACT

A liquid ejection head includes a nozzle, a pressure chamber that is capable of storing liquid and communicates with the nozzle, a volume of the pressure chamber being varied to eject the liquid from the nozzle, an actuator configured to vary the volume of the pressure chamber in response to a drive signal, and a drive circuit configured to generate the drive signal. The pressure chamber has one of states including: a steady state in which the volume is unchanged, an expanded state in which the volume is expanded, and a contracted state in which the volume is contracted. The drive signal includes first through fourth waveforms. A duration of the fourth waveform is shorter than a duration of the third waveform, and is at least 1 μs or 0.5 times a half cycle of a main acoustic resonance frequency of the liquid in the pressure chamber.

### CROSS-REFERENCE TO RELATED APPLICATION

This application is based upon and claims the benefit of priority from Japanese Patent Application No. 2024-081238, filed on May 17, 2024, the entire contents of which are incorporated herein by reference.

### FIELD

Embodiments described herein relate generally to a liquid ejection head and a liquid ejection apparatus.

### BACKGROUND

In recent years, in a liquid ejection apparatus such as an ink jet printer, there is increasing demand to achieve printing performance such as high image quality, high resolution, and ejection stability. A liquid ejection head of the liquid ejection apparatus includes a plurality of nozzles, a plurality of pressure chambers provided corresponding to the nozzles and filled with ink, a plurality of piezoelectric elements corresponding to the pressure chambers, and a drive device that applies a drive signal to the piezoelectric elements.

In such a liquid ejection head, in order to prevent generation of satellite and ink mist without impairing ejection stability of main ink droplets, the drive waveform applied to an actuator includes: a first pulse for ejecting ink droplets, a second pulse for contracting the pressure chamber from a steady state after the ejection of the ink droplets and then returning the pressure chamber to the steady state to attenuate residual vibration, and an expansion pulse for expanding a volume of the pressure chamber to such an extent that ink is not ejected after the attenuation of the residual vibration so as to prevent generation of satellite drops.

Furthermore, in order to change an ejection amount without changing a head structure, it is possible to use a drive waveform including an auxiliary pulse, an ejection pulse, a cancel pulse, and a damping pulse in this order. However, if a width of an expansion pulse or a damping pulse is short, large voltage fluctuation may occur in adjacent actuators due to electrical crosstalk, which may cause a latch-up phenomenon.

### BRIEF DESCRIPTION OF THE DRAWINGS

FIG. 1 is a perspective view illustrating a liquid ejection head according to an embodiment.

FIG. 2 is a plan view illustrating a configuration of the liquid ejection head.

FIG. 3 is a plan view illustrating a configuration of a part of the liquid ejection head.

FIG. 4 is a cross-sectional view illustrating the configuration of the part of the liquid ejection head.

FIG. 5 is a schematic view illustrating a liquid ejection apparatus.

FIG. 6 is a diagram illustrating a drive waveform applied by the liquid ejection head.

FIG. 7 is a view illustrating liquid ejection states achieved by the liquid ejection head.

### DETAILED DESCRIPTION

In general, according to one embodiment, a liquid ejection head and a liquid ejection apparatus capable of ejecting an appropriate amount of liquid while preventing a latch-up phenomenon are provided.

In one embodiment, a liquid ejection head comprises: a nozzle; a pressure chamber that is capable of storing liquid and communicates with the nozzle, a volume of the pressure chamber being varied to eject the liquid from the nozzle; an actuator configured to vary the volume of the pressure chamber in response to a drive signal; and a drive circuit configured to generate the drive signal. The pressure chamber has one of states including: a steady state in which the volume is unchanged, an expanded state in which the volume is expanded, and a contracted state in which the volume is contracted. The drive signal includes: a first waveform that causes the pressure chamber to transition from the steady state to the contracted state, and then transition from the contracted state to either the steady state or the expanded state, a second waveform for causing the liquid to be ejected from the nozzle, wherein the second waveform is subsequent to the first waveform and causes the pressure chamber to transition either from the steady state to the expanded state, and then transition from the expanded state to the steady state, or directly transition from the expanded state to the steady state, a third waveform that is subsequent to the second waveform and causes the pressure chamber to transition from the steady state to the contracted state, and then transition from the contracted state to the steady state, and a fourth waveform that is subsequent to the third waveform and causes the pressure chamber to transition from the steady state to the expanded state, and then transition from the expanded state to the steady state, and a duration of the fourth waveform is shorter than a duration of the third waveform, and is at least 1 μs or 0.5 times a half cycle of a main acoustic resonance frequency of the liquid in the pressure chamber so that the fourth waveform does not cause the liquid to be ejected from the nozzle.

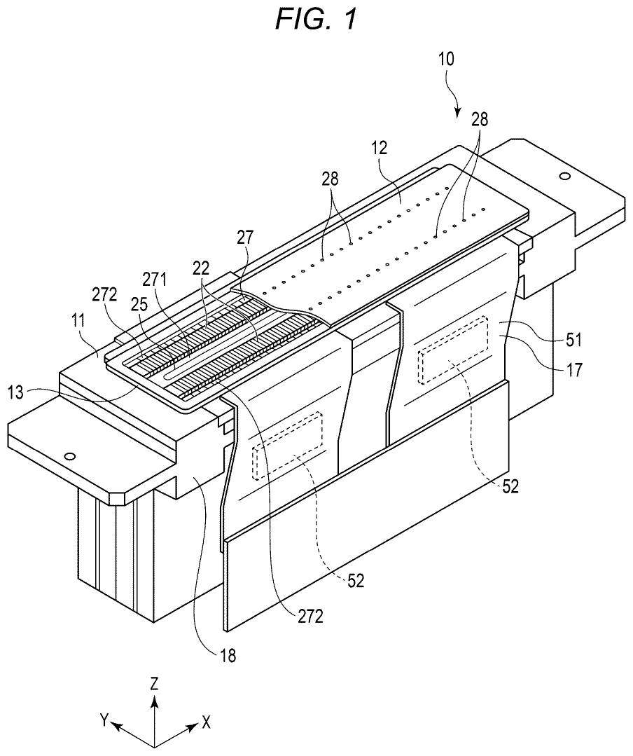

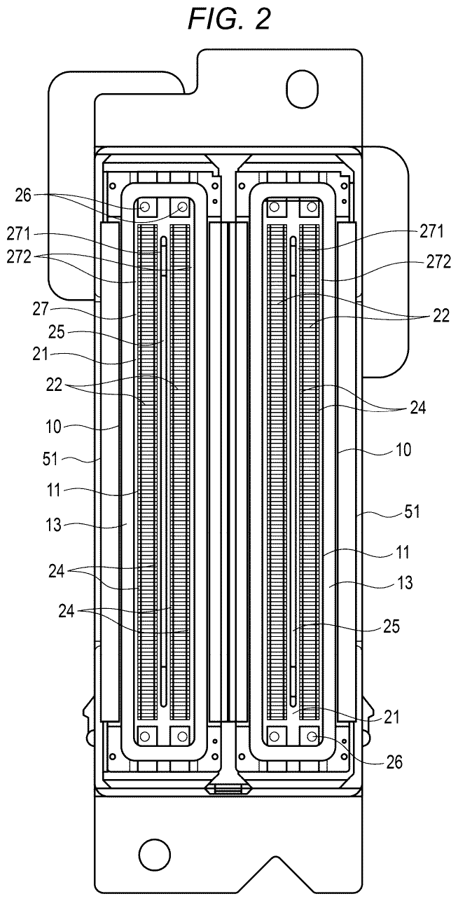

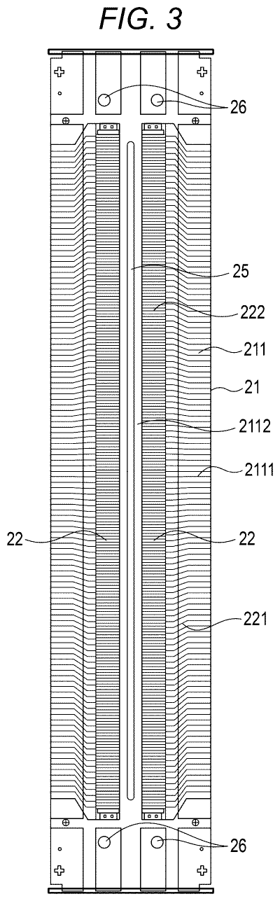

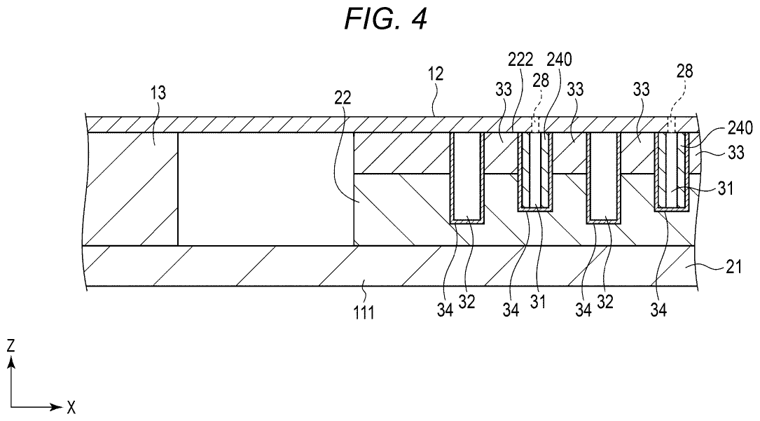

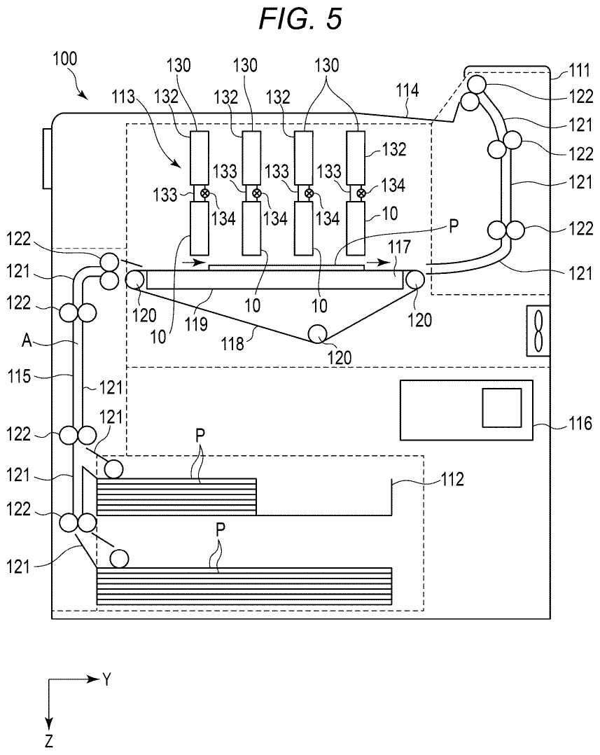

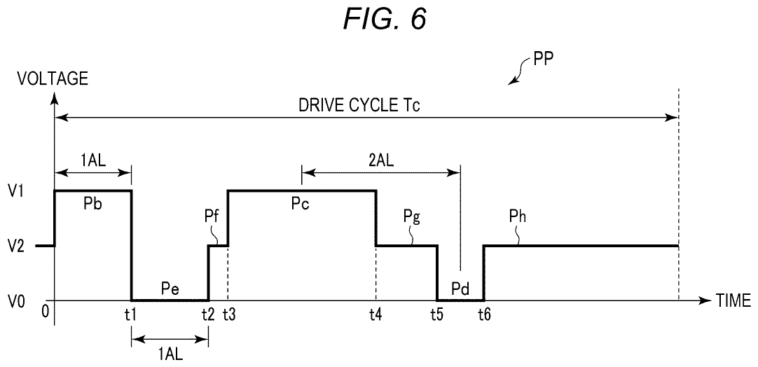

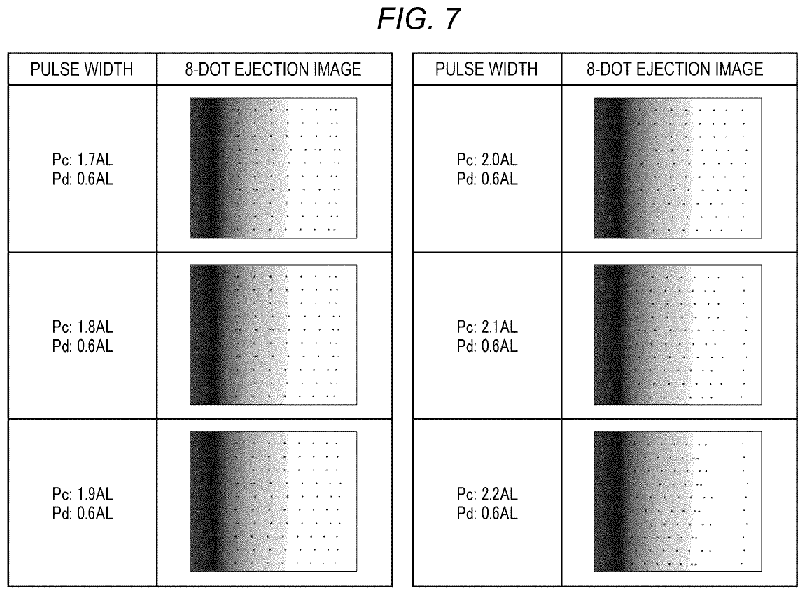

Hereinafter, a liquid ejection head 10 such as an ink jet head and a liquid ejection apparatus 100 using the liquid ejection head 10 such as an ink jet printer according to a first embodiment will be described with reference to FIGS. 1 to 5. FIG. 1 is a perspective view illustrating the liquid ejection head 10, and FIG. 2 is a plan view illustrating a configuration of the liquid ejection head 10. FIG. 3 is a plan view illustrating a configuration of a part of the liquid ejection head 10, and FIG. 4 is a cross-sectional view showing a part of the liquid ejection head 10. FIG. 5 is a schematic view illustrating the liquid ejection apparatus 100. FIG. 6 is a diagram illustrating a drive waveform PP. FIG. 7 is a diagram illustrating a liquid ejection state according to the drive waveform PP generated by the liquid ejection head 10. In the drawings, a configuration is illustrated enlarged, reduced, or omitted as appropriate for the purpose of description.

The liquid ejection head 10 is an ink jet head of a so-called side shooter type and a shear mode shared wall type. Two ink jet heads 10 each having a pair of actuators may be combined to form a head unit having a four-row integrated structure. The liquid ejection head 10 is a device for ejecting ink, and is, for example, mounted inside an ink jet printer. For example, the liquid ejection head 10 is supplied with ink serving as a liquid stored in an ink tank 132. The liquid ejection head 10 may be a non-circulation type head that does not circulate ink, or may be a circulation type head that circulates ink.

In FIG. 1 and the like, only one head main body serving as the liquid ejection head 10 is illustrated. For example, the liquid ejection head 10 is an independently driven ink jet head in which pressure chambers 31 and dummy chambers 32 are alternately arranged. The dummy chamber 32 is an air chamber to which no ink is supplied, and does not include a nozzle 28.

As illustrated in FIGS. 1 to 4, the liquid ejection head 10 includes an actuator base 11, a nozzle plate 12, and a frame 13. The actuator base 11 is a base part of the liquid ejection head 10. An ink chamber 27 to which a liquid suck as ink is supplied is formed inside the liquid ejection head 10. The liquid ejection head 10 further includes components such as a drive circuit 17 serving as a drive device that controls the liquid ejection head 10 and a manifold 18 that forms a part of a path between the liquid ejection head 10 and an ink tank.

The actuator base 11 includes a substrate 21, a pair of actuators 22, and a cover member 24.

The substrate 21 is formed in a rectangular plate shape, and is formed of ceramics such as alumina. The substrate 21 has a flat mounting surface. The pair of actuators 22 are joined to the mounting surface of the substrate 21. A supply hole 25 and a discharge hole 26 are formed in the substrate 21. Pattern wiring 211 or an electrode is formed on the substrate 21 of the actuator base 11.

The supply hole 25 is a through hole extending along a longitudinal direction of the actuator 22 between the pair of actuators 22 and in a central portion of the substrate 21. The supply hole 25 communicates with an ink supply portion of the manifold 18. The supply hole 25 is coupled to an ink tank via the ink supply portion. The supply hole 25 supplies ink in the ink tank to the ink chamber 27.

The discharge hole 26 is an outlet through which ink is discharged. The discharge hole 26 is a through hole that passes through the substrate 21, and a plurality of the discharge holes 26, for example, four discharge holes 26, are provided. The discharge hole 26 communicates with an ink discharge portion of the manifold 18 and discharges ink in the ink chamber 27.

The pair of actuators 22 are joined to the mounting surface of the substrate 21. The pair of actuators 22 are arranged in two rows on the substrate 21 with the supply hole 25 interposed therebetween. Each actuator 22 is formed of two plate-shaped piezoelectric bodies made of, for example, lead zirconate titanate (PZT). The two piezoelectric bodies are attached to each other such that polarization directions are opposite to each other in a thickness direction.

The actuators 22 are arranged in parallel in the ink chamber 27 at positions corresponding to the nozzles 28 arranged in two rows. In the actuator 22, the ink chamber 27 is divided into a first common chamber 271 and two second common chambers 272.

The actuator 22 is formed to have a trapezoidal cross section. A longitudinal direction of a side surface portion 221 of the actuator 22 extends along the row direction, and has an inclined surface inclined relative to the extending direction and an ejection direction. That is, the actuator 22 is formed to have a trapezoidal shape in a cross-sectional view orthogonal to the row direction. A top portion 222 of the actuator 22 is joined to the nozzle plate 12. The actuator 22 has a plurality of wall-shaped drive elements 33, and has grooves constituting the pressure chambers 31 and the dummy chambers 32 between the drive elements 33. In other words, the drive element 33 is formed between the grooves for forming the pressure chamber 31 and the dummy chamber 32.

The pressure chambers 31 and the dummy chambers 32 are alternately arranged. The pressure chambers 31 and the dummy chambers 32 each extend in a direction intersecting the longitudinal direction of the actuator 22, and a plurality of the pressure chambers 31 and a plurality of the dummy chambers 32 are arranged in parallel in a first direction (i.e., X axis in the drawing) which is the longitudinal direction of the actuator 22.

The drive element 33 is formed between the pressure chamber 31 and the dummy chamber 32, and is deformed according to a drive signal to change a volume of the pressure chamber 31.

The plurality of pressure chambers 31 communicates with a plurality of the nozzles 28 in the nozzle plate 12 joined to the top portion 222. Both ends of the pressure chamber 31 in a second direction communicate with the ink chamber 27. That is, one end portion opens to the first common chamber 271 of the ink chamber 27, and the other end portion opens to the second common chamber 272 of the ink chamber 27. Therefore, ink flows in from the one end portion of the pressure chamber 31, and the ink flows out from the other end portion. The pressure chamber 31 may have a throttle portion 240 where openings at both ends in the second direction are partially closed to increase flow path resistance. The throttle portion 240 increases fluid resistance by, for example, reducing a cross-sectional area of a flow path of the pressure chamber 31 orthogonal to the second direction to be smaller than that in the pressure chamber 31. The throttle portion 240 is configured such that a width dimension in a direction intersecting the second direction which is the extending direction of the pressure chamber 31, for example, in the first direction or a third direction is narrowed at an inlet and an outlet at both ends of the pressure chamber 31. For example, the throttle portion 240 is formed by closing a part of a flow path between the pressure chamber 31 and the ink chamber 27.

One side of the dummy chamber 32 in the third direction is closed by the nozzle plate 12 joined to the top portion 222, and both sides of the dummy chamber 32 in the second direction are closed by the cover member 24.

The grooves for forming the pressure chambers 31 communicate with the first common chamber 271 and the second common chamber 272.

The drive element 33 is provided with an electrode layer 34. The electrode layer 34 is formed of, for example, a nickel thin film. The electrode layer 34 extends from a bottom portion of the groove for forming the pressure chamber 31 or the dummy chamber 32 to above the substrate 21 and is connected to the pattern wiring 211. For example, the electrode layer 34 of the pressure chamber 31 is connected to individual wiring 2111 on the mounting surface of the actuator base 11, and forms an individual electrode. The electrode layer 34 of the dummy chamber 32 is connected to common wiring 2112 on the mounting surface of the actuator base 11, and forms a common electrode. The electrode layer 34 is connected to a control unit 116 via the pattern wiring 211 and the drive circuit 17, and is driven under the control of a processor of the control unit 116.

The nozzle plate 12 is formed of, for example, a rectangular film made of polyimide. The nozzle plate 12 faces the mounting surface of the actuator base 11. A plurality of the nozzles 28 that passes through the nozzle plate 12 in a thickness direction is formed in the nozzle plate 12.

The number of the plurality of the nozzles 28 is the same as the number of the pressure chambers 31, and the nozzles 28 are disposed in a manner of facing the pressure chambers 31. The plurality of nozzles 28 is arranged in the first direction, and is arranged in two rows corresponding to the pair of actuators 22. Each nozzle 28 is formed in a cylindrical shape with an axis extending in the third direction. For example, a diameter of the nozzle 28 may be constant, or the diameter of the nozzle 28 may be reduced toward a central portion or a tip end portion. The nozzle 28 is disposed in a manner of facing an intermediate portion in the extending direction of the pressure chamber 31 formed in each of the pair of actuators 22, and communicates with the pressure chamber 31. One nozzle 28 is disposed in one pressure chamber 31 at a central portion in the longitudinal direction.

The frame 13 is formed of, for example, a nickel alloy, and is formed in a rectangular frame shape. The frame 13 is interposed between the mounting surface of the actuator base 11 and the nozzle plate 12. The frame 13 is joined to the mounting surface of the actuator base 11 and the nozzle plate 12. That is, the nozzle plate 12 is attached to the actuator base 11 via the frame 13.

The manifold 18 is joined to the actuator base 11 on a side opposite to the nozzle plate 12. An ink supply portion which is a flow path communicating with the supply hole 25 and an ink discharge portion which is a flow path communicating with the discharge hole 26 are formed inside the manifold 18.

The drive circuit 17 includes various wiring substrates 51 and a driver IC 52. The drive circuit 17 causes the driver IC 52 to drive the drive element 33 by applying a drive voltage to pattern wiring to increase or decrease the volume of each pressure chamber 31, and causes liquid droplets to be ejected from the corresponding nozzle 28 disposed in a manner of facing one another. The driver IC 52 is electrically connected to the electrode layer 34 via wiring of the wiring substrate 51 and the pattern wiring 211.

In the liquid ejection head 10 configured as described above, the ink chamber 27 surrounded by the actuator base 11, the nozzle plate 12, and the frame 13 is formed. That is, the ink chamber 27 is formed between the actuator base 11 and the nozzle plate 12. For example, the ink chamber 27 is divided into three sections in the second direction by the two actuators 22, and includes the two second common chambers 272 serving as common chambers into which the discharge hole 26 opens, and the first common chamber 271 serving as a common chamber into which the supply hole 25 opens. The first common chamber 271 and the second common chamber 272 communicate with the plurality of pressure chambers 31.

In the liquid ejection head 10 configured as described above, ink circulates between the ink tank and the ink chamber 27 through the supply hole, the pressure chamber, and the discharge hole. For example, in response to a signal input from the control unit 116 of the liquid ejection apparatus 100, the driver IC 52 applies a drive voltage to the electrode layer 34 via wiring of the wiring substrate 51 such as a film, thereby generating a potential difference between the electrode layer 34 of the pressure chamber 31 and the electrode layer 34 of the dummy chamber 32 to selectively deform the drive element 33 in a shear mode. That is, the drive element 33 formed between the pressure chamber 31 and the dummy chamber 32 is deformed by the control unit 116 or the drive circuit 17 serving as a drive device according to a drive signal, thereby changing the volume of the pressure chamber 31 and ejecting liquid droplets from the nozzle 28.

Hereinafter, an example of the liquid ejection apparatus 100 including the liquid ejection head 10 will be described with reference to FIG. 5. The liquid ejection apparatus 100 includes a housing 111, a medium supply unit 112, an image forming unit 113, a medium discharge unit 114, a conveyance device 115, and the control unit 116 which is an example of a drive device.

The liquid ejection apparatus 100 executes image forming processing on a printing medium such as a sheet P by ejecting a liquid such as ink while conveying the sheet P along a predetermined conveyance path A from the medium supply unit 112 to the medium discharge unit 114 through the image forming unit 113.

The housing 111 is an outer shell of the liquid ejection apparatus 100. A discharge port through which the sheet P is to be discharged to the outside is provided at a predetermined position of the housing 111.

The medium supply unit 112 includes a plurality of sheet feed cassettes, and can hold a plurality of the sheets P of various sizes in a manner of stacking the sheets P.

The medium discharge unit 114 includes a sheet discharge tray that can hold the sheet P discharged from the discharge port.

The image forming unit 113 includes a support portion 117 that supports the sheet P, and a plurality of head units 130 that is disposed in a manner of facing the support portion 117 above the support portion 117.

The support portion 117 includes a conveyance belt 118 provided in a loop shape in a predetermined region where image formation is performed, a support plate 119 that supports the conveyance belt 118 from a back side, and a plurality of belt rollers 120 provided on the back side of the conveyance belt 118.

During image formation, the support portion 117 supports the sheet P on a holding surface that is an upper surface of the conveyance belt 118, and conveys the sheet P to a downstream side by sending the conveyance belt 118 at a predetermined timing by rotation of the belt rollers 120.

The head unit 130 includes a plurality of liquid ejection heads 10, the ink tanks 132 as liquid tanks respectively mounted on the liquid ejection heads 10, connection flow paths 133 that connect the liquid ejection heads 10 and the ink tanks 132, and circulation pumps 134 that are circulation portions. The head unit 130 is a circulation-type head unit that causes liquid to constantly circulate in the ink tank 132, and the pressure chamber 31, the dummy chamber 32, and the ink chamber 27 that are formed inside the liquid ejection head 10.

For example, the liquid ejection heads 10 of four colors: cyan, magenta, yellow, and black, and the ink tanks 132 that respectively store ink of these colors are provided. The ink tank 132 is connected to the liquid ejection head 10 by the connection flow path 133. The connection flow path 133 includes a supply flow path connected to a supply port of the liquid ejection head 10 and a collection flow path connected to a discharge port of the liquid ejection head 10.

A negative pressure control device such as a pump (not illustrated) is connected to the ink tank 132. A negative pressure in the ink tank 132 is controlled by the negative pressure control device according to the hydraulic head value between the liquid ejection head 10 and the ink tank 132, thereby forming the ink supplied to each nozzle 28 of the liquid ejection head 10 into a meniscus having a predetermined shape.

The circulation pump 134 is, for example, a liquid sending pump formed of a piezoelectric pump. The circulation pump 134 is provided in a supply flow path. The circulation pump 134 is connected to a drive circuit of the control unit 116 through wiring, and is configured to be controllable under the control of a central processing unit (CPU). The circulation pump 134 causes a liquid to circulate in a circulation flow path including the liquid ejection head 10 and the ink tank 132.

The conveyance device 115 conveys the sheet P along the conveyance path A from the medium supply unit 112 to the medium discharge unit 114 through the image forming unit 113. The conveyance device 115 includes a plurality of guide plate pairs 121 disposed along the conveyance path A and a plurality of conveyance rollers 122.

Each of the plurality of guide plate pairs 121 includes a pair of plate members disposed in a manner of facing each other across the sheet P to be conveyed, and guides the sheet P along the conveyance path A.

The conveyance roller 122 is driven and rotated under the control of the control unit 116, thereby conveying the sheet P to the downstream side along the conveyance path A. Sensors that detect a sheet conveyance state are disposed at various positions in the conveyance path A.

The control unit 116 is, for example, a control circuit board. The control unit 116 includes a processor, a read only memory (ROM), a random access memory (RAM), an I/O port that is an input and output port, and an image memory.

The processor is a processing circuit such as a CPU or a controller. The processor controls a head unit, a drive motor, an operation unit, and various sensors through the I/O port. The processor transmits printing data stored in the image memory to the drive circuit 17 in a drawing order.

The printing data is data to be input to a liquid ejection head 10, which is converted from image data or the like including image information about a color and a density of each area so as to eject a liquid. The liquid ejection head 10 inputs a drive signal corresponding to the input printing data to the drive circuit 17, and applies a drive waveform to each drive element 33 of an actuator portion via the drive circuit 17.

In the liquid ejection apparatus 100 configured as described above, for example, when the control unit 116 detects a print instruction that is input by a user through an operation panel, the control unit 116 drives the liquid ejection head 10 by driving the conveyance device 115 to convey the sheet P and outputting a printing signal to the head unit 130 at a predetermined timing. As an ejection operation, the liquid ejection head 10 transmits a drive signal to the driver IC 52 according to an image signal corresponding to image data, and applies a drive voltage to the electrode layer 34 of the actuator 22 via wiring to selectively drive the drive element 33 which is a side wall portion of the actuator 22, thereby ejecting ink from the nozzle 28 and forming an image on the sheet P held on the conveyance belt 118. As a liquid ejection operation, the control unit 116 drives the circulation pump 134 to circulate the liquid in a circulation flow path passing through the ink tank 132 and the liquid ejection head 10. In a circulation operation, the ink in the ink tank 132 is supplied from the supply hole 25 to the first common chamber 271 of the ink chamber 27 through the ink supply portion of the manifold 18 by driving the circulation pump 134. The ink is supplied to the plurality of pressure chambers 31 and the plurality of dummy chambers 32 of the pair of actuators 22. The ink flows into the second common chamber 272 of the ink chamber 27 through the pressure chamber 31 and the dummy chamber 32. The ink is discharged from the discharge hole 26 to the ink tank 132 through the ink discharge portion of the manifold 18.

Hereinafter, features of the liquid ejection head 10 and a drive waveform according to a drive signal generated by the drive circuit 17 of the liquid ejection head 10 or the control unit 116 will be described. For example, the liquid ejection head 10 produces liquid droplets corresponding to pixel data by supplying an ejection waveform as a drive waveform to the drive element of the actuator and ejecting ink.

For example, the control unit 116 and the drive circuit 17 function as a drive waveform generation unit that generates and outputs, based on the printing data, a predetermined drive waveform by switching a voltage value to be applied to the target drive element 33 among three or more kinds of voltages and setting the drive waveform to be applied to each drive element.

FIG. 6 is a diagram illustrating a drive waveform according to an embodiment. In the drive waveform illustrated in FIG. 6, the vertical axis represents potential and the horizontal axis represents time. The drive waveform PP is an ejection waveform in which a liquid is ejected once from the nozzle 28 by expansion and contraction of the pressure chamber. For the drive waveform illustrated in FIG. 6, the actual waveform is defined by a voltage potential difference between the adjacent pressure chambers. For example, a case will be described in which switching is performed among three voltage values of an expansion voltage (V0) for expanding the pressure chamber, a contraction voltage (V1) for contracting the pressure chamber, and a steady voltage (V2) which is a reference voltage and is a voltage between the expansion voltage and the contraction voltage.

FIG. 6 illustrates the drive waveform PP according to Example 1. The drive waveform PP includes an auxiliary pulse Pb, an ejection pulse Pe, a cancel pulse Pc, and a damping pulse Pd in this order. A time cycle of the drive waveform PP is a drive cycle Tc. The drive waveform PP includes steady elements Pf, Pg, and Ph that maintain a steady state (or a reference state), which is a state of waiting for printing in which, for example, the steady voltage V2 is applied to a piezoelectric body for a predetermined time, after the ejection pulse Pe, the cancel pulse Pc, and the damping pulse Pd.

That is, the drive circuit 17 first applies the auxiliary pulse Pb of the contraction voltage (V1) from the steady state (V2), then applies the ejection pulse Pe of the expansion voltage (V0) without returning a voltage to the steady state, then applies the cancel pulse Pc of the contraction voltage (V1) after the steady state (V2) is maintained for a predetermined time (i.e., from t2 to t3), then applies the damping pulse Pd of the expansion voltage (V0) after the steady state is maintained for a predetermined time (i.e., from t4 to t5) and maintains the damping pulse (Pd) for a predetermined time (i.e., from t5 to t6), and thereafter, maintains the voltage in the steady state for a predetermined time.

The auxiliary pulse Pb has a waveform for contracting the pressure chamber immediately before an expansion element of the ejection pulse Pe and accelerates ejected ink droplets. With the auxiliary pulse Pb, the drive circuit 17 increases a voltage from the steady voltage V2 to the contraction voltage V1, and reduces the voltage to the expansion voltage V0 at a timing t1 after a predetermined time elapses. An application time of the auxiliary pulse (Pb) is preferably a half cycle (i.e., 1 acoustic length (AL)) of a main acoustic resonance frequency of a liquid in the pressure chamber. Alternatively, the application time may be less than a half cycle (i.e., less than 1 AL) of the main acoustic resonance frequency, or may be three times or more of the half cycle of the main acoustic resonance frequency.

The ejection pulse Pe has a waveform for reducing a voltage from the contraction voltage V1 to the expansion voltage V0, and then increasing the voltage to the steady voltage V2 at a timing t2 after a predetermined time elapses. That is, after the auxiliary pulse Pb, the drive circuit 17 does not return the pressure chamber to the steady state, but maintains the expansion voltage V0 for a predetermined time (i.e., from t1 to t2) as the ejection pulse Pe, and then returns a voltage to the steady voltage V2 to return the pressure chamber from an expansion state to the steady state and cause ink droplets to be ejected from the nozzle. An application time (i.e., from t1 to t2) of the ejection pulse Pe is preferably a half cycle (i.e., 1 AL) of the main acoustic resonance frequency of the liquid in the pressure chamber.

The cancel pulse Pc has a waveform for increasing a voltage from the steady voltage V2 to the contraction voltage V1 after the steady element Pf after the ejection pulse Pe. After a predetermined time (i.e., from t2 to t3) elapses after the pressure chamber is returned to the steady state by the ejection pulse Pe, the drive circuit 17 increases the voltage from the steady voltage V2 to the contraction voltage V1 at a timing t3 to contract the volume in the pressure chamber from the steady state as the cancel pulse Pc. The application of the cancel pulse Pc attenuates residual vibration. After the application of the cancel pulse Pc, the drive circuit 17 applies the steady voltage V2 again, thereby returning the volume in the pressure chamber to the steady state again. In order to obtain a sufficient ejection amount, a standby time (Pf: from t2 to t3) in the steady state after the ejection pulse Pe is preferably 0.5 AL or less. The application time from t3 to t4 of the cancel pulse Pc is 1.9 AL or more and 2.0 AL or less.

Further, after a predetermined time (i.e., from t4 to t5) elapses after the pressure chamber is returned to the steady state after the application of the cancel pulse Pc, the drive circuit 17 applies the damping pulse Pd under a condition that ink is not ejected, and performs damping to prevent latch-up.

The damping pulse Pd has a waveform for reducing the voltage from the steady voltage V2 to the expansion voltage V0 after the steady element Pg after the cancel pulse Pc. The expansion voltage is, for example, 0 V. In order to prevent large voltage fluctuation, an application time (i.e., from t5 to t6) of the damping pulse Pd is set to 0.5 AL or more or 1 μs or more. In order to obtain steady ejection, the application time (i.e., from t5 to t6) of the damping pulse Pd is shorter than the application time (i.e., from t3 to t4) of the cancel pulse Pc. The drive circuit 17 has the steady element Ph that returns the voltage to the steady voltage V2 again after the application of the damping pulse Pd and maintains the steady state for a predetermined time.

A time from the center of a pulse width of the cancel pulse Pc to the center of a pulse width of the damping pulse Pd is 1.5 AL or more and 2.5 AL or less, and for example, is 2.0 AL in the present embodiment.

FIG. 7 illustrates landing positions under a plurality of different conditions when a plurality of liquid droplets is sequentially ejected from the plurality of nozzles 28 as an example of an evaluation result in which the pulse width of the cancel pulse Pc is changed. A vertical direction in FIG. 7 corresponds to an arrangement direction of the nozzles 28. FIG. 7 illustrates an ejection state of liquid droplets from eight of the nozzles 28, and illustrates how the liquid droplets land in order from the right to the left along a horizontal direction. That is, in FIG. 7, a right end dot of each column indicates a first dot landing position, and subsequent liquid droplets are arranged in order on a left side. Experimental conditions were as follows: the standby time (Pf: from t2 to t3) in the steady state after the ejection pulse Pe was 0.25 AL, the application time of the damping pulse Pd was 0.6 AL, and a pulse center time difference between the cancel pulse Pc and the damping pulse Pd was 2 AL. The experimental conditions were that the application time of the cancel pulse Pc was changed in a range from 1.7 AL to 2.2 AL, and the application time of the damping pulse Pd was 0.6 AL.

According to FIG. 7, it can be found that when the pulse width of Pc is 1.7 AL or 1.8 AL, an interval between two dots at the right end is narrowed in first columns of a plurality of dots arranged in lateral. On the other hand, when the pulse width is 2.1 AL or 2.2 AL, the interval between two dots at the right end is large. On the other hand, when the application time is 1.9 to 2.0 AL, landing positions in the columns of the plurality of dots arranged in lateral are aligned at equal intervals.

From these experimental results, it is found that the application time of the cancel pulse (Pc) for obtaining an appropriate inter-dot distance is about 1.9 to 2.0 AL when eight dots are ejected at a drive frequency of 26 kHz.

According to the drive device and the liquid ejection head 10 configured as described above, in the drive waveform including the auxiliary pulse, the ejection pulse, the cancel pulse, and the damping pulse, ejection can be stabilized by setting the application time of the damping pulse to be shorter than the application time of the cancel pulse. In addition, by setting the application time (i.e., t5 to t6) of the damping pulse (Pd) to 0.5 AL or more, or 1 μs or more, it is possible to prevent electrical crosstalk and prevent large voltage fluctuation of adjacent drive elements, and thus it is possible to prevent latch-up.

According to the drive device and the liquid ejection head 10, since the application time of the auxiliary pulse is set to be one time or less of AL, or three times or more of AL, it is possible to maintain high ejection performance.

In the drive device and the liquid ejection head 10, since a time up to when the pressure chamber is contracted from the steady state after the ejection of liquid droplets is set to 0.5 times or less of AL, an ejection amount of liquid volume can be ensured.

Further, in the drive device and the liquid ejection head 10, since a time difference between the center of the damping pulse and the center of the cancel pulse is 1.5 times to 2.5 times of AL, an ejection speed can be made uniform and dot landing can be positioned uniformly.

Embodiments according to the present disclosure are not limited to the above-described configuration. For example, in the above-described embodiments, the drive circuit 17 including the driver IC 52 provided in the liquid ejection head 10 and the control unit 116 are exemplified as an example of the drive device, however, embodiments of this disclosure are not limited thereto. For example, various control devices such as a control device connected to the liquid ejection head 10 and provided outside the liquid ejection head 10 may be used as the drive device.

The waveform is not limited to one type, and may be a combination of a plurality of types of waveforms. For example, the embodiments described herein may be applied to a drive waveform applied to any one of the plurality of drive elements 33 at any timing, and driving may be performed using a combination with another different waveform. For example, the drive waveform PP may be a part of a multi-drop waveform for ejecting liquid droplets according to a plurality of ejection waveforms, or may be a single waveform for ejecting liquid droplets according to a single ejection waveform.

Although the highest voltage value V1, the lowest voltage value V0, and the intermediate voltage value V2 are illustrated in the drawings, embodiments of this disclosure are not limited thereto, and other voltage values may be set.

Each voltage value of the drive waveform can be appropriately changed, and a voltage value applied to each piezoelectric column can be appropriately adjusted according to various conditions. For example, a voltage potential difference may be generated by grounding one of adjacent piezoelectric columns and applying a voltage to the other piezoelectric column, or a potential difference may be generated by applying voltages to both of the adjacent piezoelectric columns. Furthermore, voltage switching is not limited to being performed among three potentials, but among four or more potentials.

The configuration of the liquid ejection head 10 is not limited to the above examples, and the liquid ejection head 10 may be used in a head of another type. For example, the liquid ejection head may be configured to drive a liquid ejection unit by causing vibration of a vibration plate provided between the pressure chamber and the drive element unit by deforming a drive element portion.

According to at least one embodiment described above, it is possible to ensure an appropriate discharge amount and prevent latch-up.

While certain embodiments have been described, these embodiments have been presented by way of examples only, and are not intended to limit the scope of the disclosure. Indeed, the novel embodiments herein may be embodied in variety of other forms; furthermore, various omissions, substitutions in the form of the embodiments described herein may be made without departing from the spirit of the disclosure. The accompanying claims and their equivalents are intended to cover such forms or modifications as would fall within the scope and spirit of the disclosure.

What is claimed is:

1. A liquid ejection head comprising:
a nozzle;
a pressure chamber that is capable of storing liquid and communicates with the nozzle, a volume of the pressure chamber being varied to eject the liquid from the nozzle;
an actuator configured to vary the volume of the pressure chamber in response to a drive signal; and
a drive circuit configured to generate the drive signal, wherein
the pressure chamber has one of states including:
a steady state in which the volume is unchanged,
an expanded state in which the volume is expanded, and
a contracted state in which the volume is contracted,
the drive signal includes:
a first waveform that causes the pressure chamber to transition from the steady state to the contracted state, and then transition from the contracted state to either the steady state or the expanded state,
a second waveform for causing the liquid to be ejected from the nozzle, wherein the second waveform is subsequent to the first waveform and causes the pressure chamber to transition either from the steady state to the expanded state, and then transition from the expanded state to the steady state, or directly transition from the expanded state to the steady state,
a third waveform that is subsequent to the second waveform and causes the pressure chamber to transition from the steady state to the contracted state, and then transition from the contracted state to the steady state, and
a fourth waveform that is subsequent to the third waveform and causes the pressure chamber to transition from the steady state to the expanded state, and then transition from the expanded state to the steady state, and
a duration of the fourth waveform is shorter than a duration of the third waveform, and is at least 1 μs or 0.5 times a half cycle of a main acoustic resonance frequency of the liquid in the pressure chamber so that the fourth waveform does not cause the liquid to be ejected from the nozzle.

2. The liquid ejection head according to claim 1, wherein
a duration of the first waveform is less than or equal to the half cycle of the main acoustic resonance frequency of the liquid.

3. The liquid ejection head according to claim 1, wherein
a duration of the first waveform is at least three times the half cycle of the main acoustic resonance frequency of the liquid.

4. The liquid ejection head according to claim 1, wherein
a duration between an end of the second waveform and a beginning of the third waveform is less than or equal to 0.5 times the half cycle of the main acoustic resonance frequency of the liquid.

5. The liquid ejection head according to claim 1, wherein
a time difference between a center of the third waveform and a center of the fourth waveform is twice the half cycle of the main acoustic resonance frequency of the liquid.

6. The liquid ejection head according to claim 1, wherein
a duration of the second waveform is the half cycle of the main acoustic resonance frequency of the liquid.

7. The liquid ejection head according to claim 6, wherein
a duration of the first waveform is equal to the duration of the second waveform.

8. The liquid ejection head according to claim 1, wherein
the drive signal is a signal of a voltage applied to the actuator, and a first voltage of a first value is applied to the actuator when the pressure chamber is in the steady state,
the first waveform includes a second voltage of a second value that is greater than the first value, and
the second waveform includes a third voltage of a third value that is lower than the first value.

9. The liquid ejection head according to claim 8, wherein
the third waveform includes a fourth voltage of the second value.

10. The liquid ejection head according to claim 9, wherein
the fourth waveform includes a fifth voltage of the third value.

11. A liquid ejection apparatus comprising:
a plurality of rollers for conveying a print medium; and
a liquid ejection head configured to eject liquid onto the conveyed medium and including:
a nozzle,
a pressure chamber that is capable of storing the liquid and communicates with the nozzle, a volume of the pressure chamber being varied to eject the liquid from the nozzle,
an actuator configured to vary the volume of the pressure chamber in response to a drive signal, and
a drive circuit configured to generate the drive signal, wherein
the pressure chamber has one of states including:
a steady state in which the volume is unchanged,
an expanded state in which the volume is expanded, and
a contracted state in which the volume is contracted,
the drive signal includes:
a first waveform that causes the pressure chamber to transition from the steady state to the contracted state, and then transition from the contracted state to either the steady state or the expanded state,
a second waveform for causing the liquid to be ejected from the nozzle, wherein the second waveform is subsequent to the first waveform and causes the pressure chamber to transition either from the steady state to the expanded state, and then transition from the expanded state to the steady state, or directly transition from the expanded state to the steady state,
a third waveform that is subsequent to the second waveform and causes the pressure chamber to transition from the steady state to the contracted state, and then transition from the contracted state to the steady state, and
a fourth waveform that is subsequent to the third waveform and causes the pressure chamber to transition from the steady state to the expanded state, and then transition from the expanded state to the steady state, and
a duration of the fourth waveform is shorter than a duration of the third waveform, and is at least 1 μs or 0.5 times a half cycle of a main acoustic resonance frequency of the liquid in the pressure chamber so that the fourth waveform does not cause the liquid to be ejected from the nozzle.

12. The liquid ejection apparatus according to claim 11, wherein
a duration of the first waveform is less than or equal to the half cycle of the main acoustic resonance frequency of the liquid.

13. The liquid ejection apparatus according to claim 11, wherein
a duration of the first waveform is at least three times the half cycle of the main acoustic resonance frequency of the liquid.

14. The liquid ejection apparatus according to claim 11, wherein
a duration between an end of the second waveform and a beginning of the third waveform is less than or equal to 0.5 times the half cycle of the main acoustic resonance frequency of the liquid.

15. The liquid ejection apparatus according to claim 11, wherein
a time difference between a center of the third waveform and a center of the fourth waveform is twice the half cycle of the main acoustic resonance frequency of the liquid.

16. The liquid ejection apparatus according to claim 11, wherein
a duration of the second waveform is the half cycle of the main acoustic resonance frequency of the liquid.

17. The liquid ejection apparatus according to claim 16, wherein
a duration of the first waveform is equal to the duration of the second waveform.

18. The liquid ejection apparatus according to claim 11, wherein
the drive signal is a signal of a voltage applied to the actuator, and a first voltage of a first value is applied to the actuator when the pressure chamber is in the steady state,
the first waveform includes a second voltage of a second value that is greater than the first value, and
the second waveform includes a third voltage of a third value that is lower than the first value.

19. The liquid ejection apparatus according to claim 18, wherein
the third waveform includes a fourth voltage of the second value.

20. The liquid ejection apparatus according to claim 19, wherein
the fourth waveform includes a fifth voltage of the third value.
